(19) United States
(12) Patent Application Publication
(10) Pub. No.: US 2022/0389884 A1
(43) Pub. Date: Dec. 8, 2022

(54) VARIABLE CYCLE JET ENGINE

(71) Applicant: RAYTHEON TECHNOLOGIES CORPORATION, Farmington, CT (US)

(72) Inventor: STEVEN W. BURD, Cheshire, CT (US)

(73) Assignee: RAYTHEON TECHNOLOGIES CORPORATION, Farmington, CT (US)

(21) Appl. No.: 17/734,370

(22) Filed: May 2, 2022

Related U.S. Application Data
(60) Provisional application No. 63/197,119, filed on Jun. 4, 2021.

(51) Int. Cl. F02K 7/10; F02C 6/00

(52) U.S. Cl. CPC F02K 7/10; F02C 6/00; F05D 2240/35; F05D 2220/74

(57) ABSTRACT

A gas turbine engine includes a core engine section, including a compressor section, a primary combustor and a turbine section positioned within a core flow path of the gas turbine engine; a ramjet section, including a supplemental combustor disposed within a ram duct, the ram duct located radially outside the core engine section; and a core engine housing positioned radially outward of the core engine section and radially inward of the ramjet section.

### CROSS-REFERENCE TO RELATED APPLICATIONS

This application is based upon and claims priority to U.S. provisional patent application 63/197,119 entitled “VARIABLE CYCLE JET ENGINE” and filed on Jun. 4, 2021, the entire content of which is incorporated herein by reference

### FIELD

The present disclosure relates generally to gas turbine engines and, more particularly, to gas turbine engines configured to transition between subsonic and supersonic speeds.

### BACKGROUND

Gas turbine engines typically include a fan section, a compressor section, a combustor section and a turbine section. The fan section drives air along a bypass flow path while the compressor section drives air along a core flow path. In general, during operation, air is pressurized in the compressor section and is mixed with fuel and burned in the combustor section to generate hot combustion gases. Efficient and thorough mixing and combustion of the fuel and air is often facilitated using swirlers disposed upstream of a combustion zone where burning of the fuel and air occurs. Subsequent to combustion, the hot combustion gases flow through the turbine section, which extracts energy from the hot combustion gases to power the compressor section and other gas turbine engine loads, such as those required to rotate fan blades in the fan section. The compressor section typically includes low-pressure and high-pressure compressors, and the turbine section includes low-pressure and high-pressure turbines. A jet engine that can operate through various modes of thrust and speed operational scenarios with more efficient consumption of fuel presents many design challenges that are being addressed.

### SUMMARY

A gas turbine engine is disclosed. In various embodiments, the gas turbine engine includes a core engine section, including a compressor section, a primary combustor and a turbine section positioned within a core flow path of the gas turbine engine; a ramjet section, including a supplemental combustor disposed within a ram duct, the ram duct located radially outside the core engine section; and a core engine housing positioned radially outward of the core engine section and radially inward of the ramjet section.

In various embodiments, the supplemental combustor is a rotating detonation combustor. In various embodiments, the rotating detonation combustor includes a fuel-air mixer configured to receive a compressed air and a fuel. In various embodiments, the rotating detonation combustor includes an annular structure positioned downstream of the fuel-air mixer and configured to combust the compressed air and the fuel. In various embodiments, the compressed air is provided to the rotating detonation combustor via the ram duct. In various embodiments, the gas turbine engine further includes a bypass duct extending through the core engine housing, the bypass duct configured to provide a bypass flow from the core engine section to the ram duct, upstream of the rotating detonation combustor.

In various embodiments, the gas turbine engine includes a high-speed spool, the compressor section includes a high-pressure compressor and the turbine section includes a high-pressure turbine, the high-pressure compressor and the high-pressure turbine being interconnected via the high-speed spool. In various embodiments, the gas turbine engine includes a low-speed spool, the compressor section includes a low-pressure compressor and the turbine section includes a low-pressure turbine, the low-pressure compressor and the low-pressure turbine being interconnected via the low-speed spool. In various embodiments, the gas turbine engine includes a single-speed spool configured to interconnect a compressor within the compressor section and a turbine within the turbine section.

In various embodiments, the core engine section is a turbofan engine comprising a fan section positioned upstream of the compressor section. In various embodiments, the gas turbine engine includes a ram inlet flow control configured to control a flow of inlet air into the ramjet section. In various embodiments, the gas turbine engine includes a core engine inlet flow control configured to control the flow of inlet air into the core engine section. In various embodiments, a bypass casing is positioned radially outward of the core engine housing and radially inward of the ram duct, the bypass casing defining a bypass duct extending between the core engine housing and the bypass casing.

A variable-cycle jet engine is disclosed. In various embodiments, the variable-cycle jet engine includes a core engine section, including a compressor section, a primary combustor and a turbine section positioned within a core flow path of the variable-cycle jet engine; a ramjet section, including a supplemental combustor disposed within a ram duct, the ram duct located radially outside the core engine section; and a core engine housing positioned radially outward of the core engine section and radially inward of the ramjet section.

In various embodiments, the supplemental combustor is a rotating detonation combustor. In various embodiments, the rotating detonation combustor includes a fuel-air mixer configured to receive a compressed air and a fuel and an annular structure positioned downstream of the fuel-air mixer and configured to combust the compressed air and the fuel. In various embodiments, the compressed air is provided to the rotating detonation combustor via the ram duct.

In various embodiments, a ram inlet flow control is configured to control a flow of inlet air into the ramjet section and a core engine inlet flow control is configured to control the flow of inlet air into the core engine section. In various embodiments, the core engine section includes a turbofan engine. In various embodiments, the core engine section includes a turbojet engine.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a cross sectional schematic view of a gas turbine engine, in accordance with various embodiments;

FIGS. 2A and 2B are schematic views of a rotating detonation combustor, in accordance with various embodiments;

FIG. 3 is a cross sectional schematic view of a gas turbine engine, in accordance with various embodiments; and

FIG. 4 is a cross sectional schematic view of a gas turbine engine, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

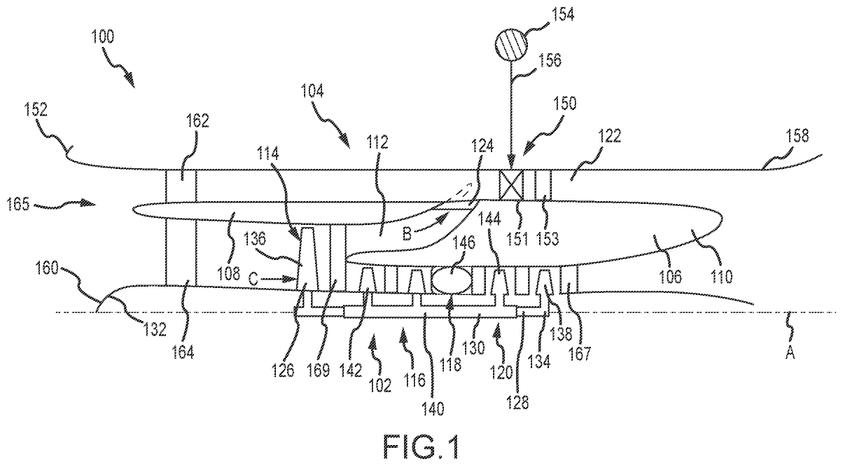

Referring now to the drawings, FIG. 1 schematically illustrates a variable-cycle jet engine 100, in accordance with various embodiments. In general, the variable-cycle jet engine 100 includes a turbofan section 102 (or a core engine section) and a ramjet section 104. While some interaction occurs between the turbofan section 102 and the ramjet section 104, as described below, the two sections are generally separated by a core engine housing 106 having a forward housing portion 108 and an aft housing portion 110, separated by a bypass duct 112 configured to transfer air flow from an upstream portion of the turbofan section 102 to the ramjet section 104.

Starting first with the turbofan section 102 of the variable-cycle jet engine 100, the turbofan section 102 is disclosed herein as a two-spool turbofan that generally incorporates a fan section 114, a compressor section 116, a combustor section 118 and a turbine section 120. The fan section 114 is configured to drive a bypass flow B (typically air) into the bypass duct 112 and then into a ram duct 122 during transition from subsonic to supersonic operation. A bypass duct blocker door 124 (shown open by the dashed lines and closed by the solid lines) is configured to selectively start and stop and modulate the driving of the bypass flow B into the ram duct 122. When the bypass duct blocker door 124 is closed, the fan section 114 may function as a low-pressure compressor 126 of the compressor section 116. The compressor section 116 drives air along a core flow path C for compression and communication into the combustor section 118 and then expansion through the turbine section 120.

The turbofan section 102 generally includes a low-speed spool 128 and a high-speed spool 130 mounted for rotation about an engine central longitudinal axis A relative to an engine static structure 132. The low-speed spool 128 generally includes an inner shaft 134 that interconnects the fan section 114 (or a fan 136) and a low-pressure turbine 138. The high-speed spool 130 includes an outer shaft 140 that interconnects a high-pressure compressor 142 and a high-pressure turbine 144. A combustor 146 (or a primary combustor) is arranged in the turbofan section 102 between the high-pressure compressor 142 and the high-pressure turbine 144. The inner shaft 134 and the outer shaft 140 are concentric and rotate about the engine central longitudinal axis A, which is collinear with longitudinal axes of the inner shaft 134 and the outer shaft 140. The air in the core flow path C is compressed by the fan 136 (or by the low-pressure compressor 126) and then the high-pressure compressor 142, mixed and burned with fuel in the combustor 146, and then expanded over the high-pressure turbine 144 and the low-pressure turbine 138. The low-pressure turbine 138 and the high-pressure turbine 144 rotationally drive, respectively, the low-speed spool 128 and the high-speed spool 130 in response to the expansion.

Still referring to FIG. 1, the ramjet section 104 includes a supplemental combustor, which, in various embodiments, may be in the form of a rotating detonation combustor 150 positioned within the ram duct 122 downstream and of the bypass duct blocker door 124. In various embodiments, compressed air from a ram inlet 152 is delivered to the rotating detonation combustor 150 via the ram duct 122 and fuel from a fuel source 154 is delivered to the rotating detonation combustor 150 via a fuel duct 156. The combustion process begins in the rotating detonation combustor 150 when the fuel-air mixture is ignited via a spark or another suitable ignition source to generate a compression wave. The compression wave is followed by a chemical reaction that transitions the compression wave to a detonation wave. The detonation wave enters a combustion chamber of the rotating detonation combustor 150 and travels along the combustion chamber. As the detonation wave consumes the air and the fuel, combustion products traveling along the combustion chamber accelerate and are discharged from the rotating detonation combustor 150, with the combustion products being exhausted through an exit nozzle 158 to propel the variable-cycle jet engine 100 in the supersonic regime. As will be described further below, in various embodiments, the rotating detonation combustor 150 includes a fuel-air mixer 151 and an annular structure 153 disposed downstream of the fuel-air mixer 151.

With continued reference to FIG. 1, during operation, air enters the variable-cycle jet engine 100 through both the ram inlet 152 and a core engine inlet 160 (e.g., a subsonic inlet). A ram inlet flow control 162 is configured to control the flow of inlet air into the ramjet section 104 and a core engine inlet flow control 164 (e.g., a subsonic inlet flow control) is configured to control the flow of inlet air into the turbofan section 102. In various embodiments, the combination of the ram inlet flow control 162 and the core engine inlet flow control 164 may be considered to comprise a bifurcated inlet 165. For example, during subsonic operation, the ram inlet flow control 162 may be substantially closed (or otherwise operated to substantially block entry of inlet air into the ram duct 122), while the core engine inlet flow control 164 may be substantially open (or otherwise operated to substantially allow entry of inlet air into the turbofan section 102). In various embodiments, the ram inlet flow control 162 may, alternatively, be substantially open during subsonic flow, allowing the ram duct 122 to be used as a pass through duct. In either manner, the variable-cycle jet engine 100 operates as previously described, generally in the fashion of a turbojet engine, where the exhaust is expended downstream of the engine and used for thrust. In various embodiments, during subsonic operation, the bypass duct blocker door 124 may be opened, thereby allowing the bypass flow B to enter the ram duct 122 and produce a bypass thrust for propulsion, in addition to the exhaust expended downstream of the engine.

In transitioning to supersonic operation, the ram inlet flow control 162 is opened (or otherwise operated to substantially allow entry of inlet air into the ramjet section 104). The bypass duct blocker door 124, if opened, is gradually closed, thereby allowing an essentially unobstructed annular passageway to the rotating detonation combustor 150. Once the flow of air through the ram duct 122 and through the rotating detonation combustor 150 is established, the rotating detonation combustor 150 is ignited, propelling the variable-cycle jet engine to operate in the supersonic regime. Once ignited, the core engine inlet flow control 164 operates to substantially block entry of inlet air into the turbofan section 102 of the variable-cycle jet engine 100. The process is similarly reversed when decelerating to subsonic speeds. To assist with the various transitions between subsonic and supersonic operation, various variable vanes or struts may be employed to control flow rates and pressure levels within the core flow C of the turbofan section 102, including an aft variable strut 167 positioned downstream of the low-pressure turbine 138 and a forward variable strut 169 positioned between the fan 136 and the high-pressure compressor 142.

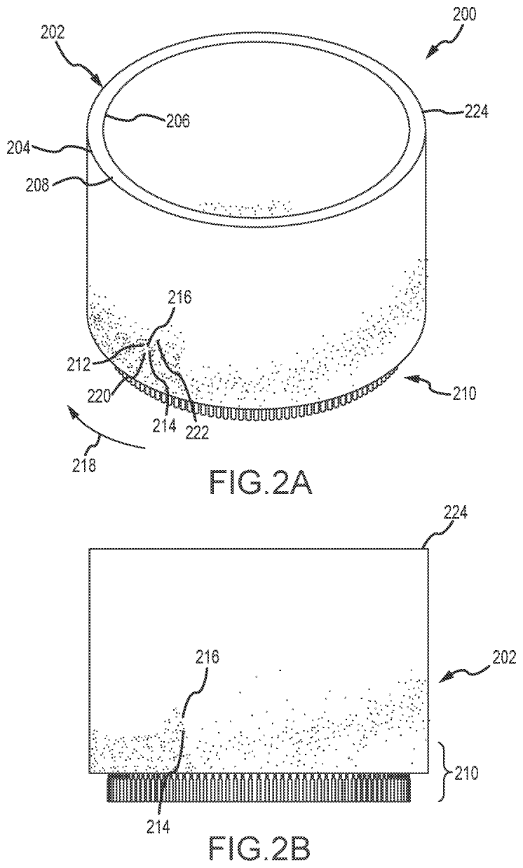

Referring now to FIGS. 2A and 2B, a rotating detonation combustor 200, similar to the rotating detonation combustor 150 described above with reference to FIG. 1, is illustrated. The rotating detonation combustor 200 may include an annular structure 202 including an outer cylinder 204 and an inner cylinder 206. The outer cylinder 204 and the inner cylinder 206 define a volume 208 therebetween. Although the rotating detonation combustor 200 is shown as an annular structure, the rotating detonation combustor 200 may have any shape that provides a continuous path for detonation to occur. For example, the rotating detonation combustor 200 may have an elliptical shape, a trapezoidal shape, or the like. In this regard, where used in this context, the term “annulus” or “annular structure” may refer to any continuous circumferential channel having an annular or any other shape such as trapezoidal or elliptical. Furthermore, where used herein, the term “annular volume” may likewise refer to any continuous circumferential channel having annular or any other shape such as trapezoidal or elliptical.

In various embodiments, a fuel-air mixer 210 is positioned upstream from the annular structure 202 and is configured to provide a fuel mixture 212 including a combustible blend of air (or oxidizer) and fuel. The combustible blend may comprise, for example, the air passing through the ram duct 122 and the fuel from the fuel source 154 described above with reference to FIG. 1. The fuel mixture 212 may be continuously introduced into the volume 208. The rotating detonation combustor 200 is then initialized, causing a detonation wave 214 to occur. The detonation wave 214 corresponds to an ignition or combustion of the fuel mixture 212 at a particular location about a circumference of the annular structure 202. The detonation wave 214 may then continuously travel around the circumference of the annular structure 202. As shown in FIG. 2A, the detonation wave 214 may occur at a location 216 and may travel in a direction illustrated by an arrow 218. A first location 220 within the volume 208 and preceding the detonation wave 214 may include a relatively large density of the fuel mixture 212. As the detonation wave 214 reaches the first location 220, the density of the fuel mixture 212 allows the fuel mixture 212 to detonate. After detonation occurs, the fuel mixture 212 is burned away and the force of the detonation wave 214 temporarily resists entry of additional amounts of the fuel mixture 212 into the volume 208. Accordingly, a second location 222 that has recently detonated may have a relatively low density of the fuel mixture 212. As a result, the detonation wave 214 continues to rotate about the volume 208 in the direction shown by the arrow 218. The detonation wave 214 generates detonation exhaust. The rotating detonation combustor 200 includes a downstream outlet 224 through which the detonation exhaust travels prior to reaching the exit nozzle 158 (see FIG. 1).

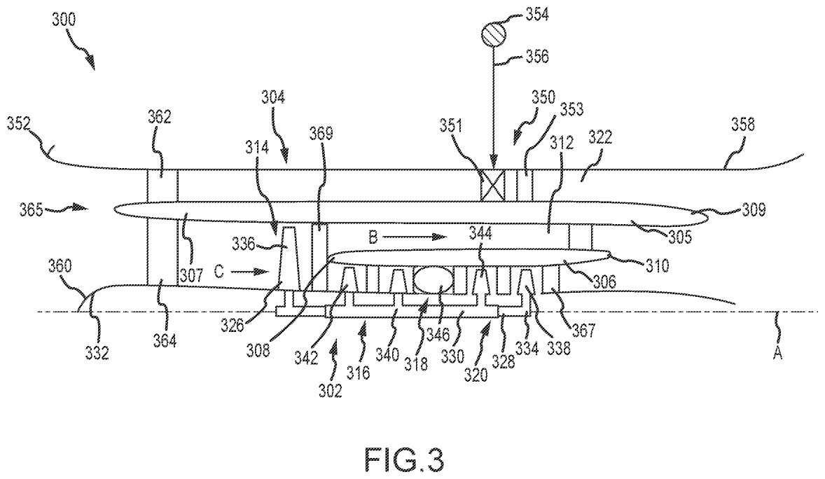

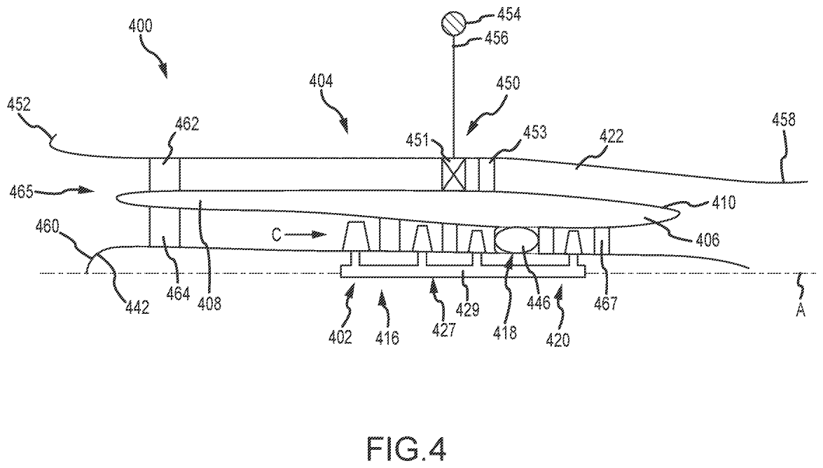

Referring now to FIGS. 3 and 4, various embodiments of variable-cycle jet engines, similar to the variable-cycle jet engine 100 described above with reference to FIG. 1 and FIGS. 2A and 2B, are described. Referring to FIG. 3, for example, a variable-cycle jet engine 300 is illustrated, in accordance with various embodiments. In general, the variable-cycle jet engine 300 includes a turbofan section 302 (or a core engine section) and a ramjet section 304. While some interaction occurs between the turbofan section 302 and the ramjet section 304, as described below, the two sections are generally separated by a bypass casing 305 having a forward bypass casing portion 307 and an aft bypass casing portion 309. Positioned radially inward of the bypass casing 305 is a core engine housing 306 having a forward housing portion 308 and an aft housing portion 310. Unlike the variable-cycle jet engine 100 described above, the core engine housing 306 does not include a bypass duct 112 (see FIG. 1) configured to transfer air flow from an upstream portion of the turbofan section 302 to the ramjet section 304.

Starting first with the turbofan section 302 of the variable-cycle jet engine 300, the turbofan section 302 is disclosed herein as a two-spool turbofan that generally incorporates a fan section 314, a compressor section 316, a combustor section 318 and a turbine section 320. The fan section 314 is configured to drive a bypass flow B (typically air) into a bypass duct 312, similar to that of a conventional high-bypass or low-bypass gas turbine engine. The compressor section 316 drives air along a core flow path C for compression and communication into the combustor section 318 and then expansion through the turbine section 320.

The turbofan section 302 generally includes a low-speed spool 328 and a high-speed spool 330 mounted for rotation about an engine central longitudinal axis A relative to an engine static structure 332. The low-speed spool 328 generally includes an inner shaft 334 that interconnects the fan section 314 (or a fan 336) and a low-pressure turbine 338. The high-speed spool 330 includes an outer shaft 340 that interconnects a high-pressure compressor 342 and a high-pressure turbine 344. A combustor 346 (or a primary combustor) is arranged in the turbofan section 302 between the high-pressure compressor 342 and the high-pressure turbine 344. The inner shaft 334 and the outer shaft 340 are concentric and rotate about the engine central longitudinal axis A, which is collinear with longitudinal axes of the inner shaft 334 and the outer shaft 340. The air in the core flow path C is compressed by the fan 336 (which may also function a low-pressure compressor 326) and then the high-pressure compressor 342, mixed and burned with fuel in the combustor 346, and then expanded over the high-pressure turbine 344 and the low-pressure turbine 338. The low-pressure turbine 338 and the high-pressure turbine 344 rotationally drive, respectively, the low-speed spool 328 and the high-speed spool 330 in response to the expansion.

Still referring to FIG. 3, the ramjet section 304 includes a supplemental combustor, which, in various embodiments, may be in the form of a rotating detonation combustor 350 positioned within a ram duct 322, located radially outward of the bypass casing 305. In various embodiments, compressed air from a ram inlet 352 is delivered to the rotating detonation combustor 350 via the ram duct 322 and fuel from a fuel source 354 is delivered to the rotating detonation combustor 350 via a fuel duct 356. As described above with reference to FIGS. 2A and 2B, in various embodiments, the rotating detonation combustor 350 includes a fuel-air mixer 351 where the fuel and air is mixed and an annular structure 353 positioned downstream of the fuel-air mixer 351 where the rotating detonation combustion process occurs. The combustion process begins in the rotating detonation combustor 350 when the fuel-air mixture is ignited via a spark or another suitable ignition source to generate a compression wave. The compression wave is followed by a chemical reaction that transitions the compression wave to a detonation wave. The detonation wave enters a combustion chamber (e.g., the annular structure 353) of the rotating detonation combustor 350 and travels along the combustion chamber. As the detonation wave consumes the air and the fuel, combustion products traveling along the combustion chamber accelerate and are discharged from the rotating detonation combustor 350, with the combustion products being exhausted through an exit nozzle 358 to propel the variable-cycle jet engine 300 in the supersonic regime.

With continued reference to FIG. 3, during operation, air enters the variable-cycle jet engine 300 through both the ram inlet 352 and a core engine inlet 360 (e.g., a subsonic inlet). A ram inlet flow control 362 is configured to control the flow of inlet air into the ramjet section 304 and a core engine inlet flow control 364 (e.g., a subsonic inlet flow control) is configured to control the flow of inlet air into the turbofan section 302. In various embodiments, the combination of the ram inlet flow control 362 and the core engine inlet flow control 364 may be considered to comprise a bifurcated inlet 365. For example, during subsonic operation, the ram inlet flow control 362 may be substantially closed (or otherwise operated to substantially block entry of inlet air into the ram duct 322), while the core engine inlet flow control 364 may be substantially open (or otherwise operated to substantially allow entry of inlet air into the turbofan section 302). In various embodiments, the ram inlet flow control 362 may, alternatively, be substantially open during subsonic flow, allowing the ram duct 322 to be used as a pass through duct. In either manner, the variable-cycle jet engine 300 operates as previously described, generally in the fashion of a turbojet engine, where the exhaust is expended downstream of the engine and used for thrust, together with the thrust generated by the air flowing through the bypass duct 312.

In transitioning to supersonic operation, the ram inlet flow control 362 is opened (or otherwise operated to substantially allow entry of inlet air into the ramjet section 304). Once the flow of air through the ram duct 322 and through the rotating detonation combustor 350 is established, the rotating detonation combustor 350 is ignited, propelling the variable-cycle jet engine to operate in the supersonic regime. Once ignited, the core engine inlet flow control 364 operates to substantially block entry of inlet air into the turbofan section 302 of the variable-cycle jet engine 300. The process is essentially reversed when decelerating to subsonic speeds. To assist with the various transitions between subsonic and supersonic operation, various variable vanes or struts may be employed to control flow rates and pressure levels within the core flow path C of the turbofan section 302, including an aft variable strut 367 positioned downstream of the low-pressure turbine 338 and a forward variable strut 369 positioned between the fan 336 and the high-pressure compressor 342.

Referring now to FIG. 4, a variable-cycle jet engine 400 is illustrated, in accordance with various embodiments. In general, the variable-cycle jet engine 400 includes a turbojet section 402 (or a core engine section) and a ramjet section 404. While some interaction occurs between the turbojet section 402 and the ramjet section 404, as described below, the two sections are generally separated by a core engine housing 406 having a forward housing portion 408 and an aft housing portion 410. Unlike the variable-cycle jet engine 100 described above, the core engine housing 406 does not include a bypass duct 112 (see FIG. 1) configured to transfer air flow from an upstream portion of the turbojet section 402 to the ramjet section 404. Similarly, unlike the variable-cycle jet engine 300 described above, the variable-cycle jet engine 400 does not include a bypass casing 305 (see FIG. 3) configured to define a bypass duct 312 (see FIG. 3) between the bypass casing 305 and the core engine housing 406. Further, it is noted that while both the embodiments described in FIGS. 1 and 3 are directed toward core engines of the turbofan design, the variable-cycle jet engine 400 replaces the turbofan-type engines with a turbojet-type engine.

Starting first with the turbojet section 402 of the variable-cycle jet engine 400, the turbojet section 402 is disclosed herein as a single-spool turbojet that generally incorporates a compressor section 416, a combustor section 418 and a turbine section 420. The compressor section 416 drives air along a core flow path C for compression and communication into the combustor section 418 and then expansion through the turbine section 420. The turbojet section 402 generally includes a single-speed spool 427 mounted for rotation about an engine central longitudinal axis A relative to an engine static structure 432. The single-speed spool 427 generally includes a single shaft 429 that interconnects the compressor section 416 and the turbine section 420. A combustor 446 (or a primary combustor) is arranged in the turbojet section 402 between the compressor section 416 and the turbine section 420. The air in the core flow path C is compressed by the compressor section 416, mixed and burned with fuel in the combustor 446, and then expanded over the turbine section 420.

Still referring to FIG. 4, the ramjet section 404 includes a supplemental combustor, which, in various embodiments, may be in the form of a rotating detonation combustor 450 positioned within a ram duct 422, located radially outward of the core engine housing 406. In various embodiments, compressed air from a ram inlet 452 is delivered to the rotating detonation combustor 450 via the ram duct 422 and fuel from a fuel source 454 is delivered to the rotating detonation combustor 450 via a fuel duct 456. As described above with reference to FIGS. 2A and 2B, in various embodiments, the rotating detonation combustor 450 includes a fuel-air mixer 451 where the fuel and air is mixed and an annular structure 453 positioned downstream of the fuel-air mixer 451 where the rotating detonation combustion process occurs. The combustion process begins in the rotating detonation combustor 450 when the fuel-air mixture is ignited via a spark or another suitable ignition source to generate a compression wave. The compression wave is followed by a chemical reaction that transitions the compression wave to a detonation wave. The detonation wave enters a combustion chamber (e.g., the annular structure 453) of the rotating detonation combustor 450 and travels along the combustion chamber. As the detonation wave consumes the air and the fuel, combustion products traveling along the combustion chamber accelerate and are discharged from the rotating detonation combustor 450, with the combustion products being exhausted through an exit nozzle 458 to propel the variable-cycle jet engine 400 in the supersonic regime. Further, it is noted that while the disclosure describes the rotating detonation combustor 450 as receiving fuel from the fuel source 454, the fuel source 454, in various embodiments, is the same fuel source used to supply fuel to the combustor 446, though the fuel supplied to the combustor 446 and the rotating detonation combustor 450 may be metered independently (e.g., by separate fuel pumps) to stage the combustion processes in each combustor independently and to manage the thermal energy directed into the ram duct 422 downstream of the rotating detonation combustor 450; the same applies to the fuel source 154 and the fuel source 354 described above with reference to FIG. 1 and FIG. 3, respectively

With continued reference to FIG. 4, during operation, air enters the variable-cycle jet engine 400 through both the ram inlet 452 and a core engine inlet 460 (e.g., a subsonic inlet). A ram inlet flow control 462 is configured to control the flow of inlet air into the ramjet section 404 and a core engine inlet flow control 464 (e.g., a subsonic inlet flow control) is configured to control the flow of inlet air into the turbojet section 402. In various embodiments, the combination of the ram inlet flow control 462 and the core engine inlet flow control 464 may be considered to comprise a bifurcated inlet 465. For example, during subsonic operation, the ram inlet flow control 462 may be substantially closed (or otherwise operated to substantially block entry of inlet air into the ram duct 422), while the core engine inlet flow control 464 may be substantially open (or otherwise operated to substantially allow entry of inlet air into the turbojet section 402). In various embodiments, the ram inlet flow control 462 may, alternatively, be substantially open during subsonic flow, allowing the ram duct 422 to be used as a pass through duct. In either manner, the variable-cycle jet engine 400 operates as previously described, generally in the fashion of a turbojet engine, where the exhaust is expended downstream of the engine and used for thrust.

In transitioning to supersonic operation, the ram inlet flow control 462 is opened (or otherwise operated to substantially allow entry of inlet air into the ramjet section 404). Once the flow of air through the ram duct 422 and through the rotating detonation combustor 450 is established, the rotating detonation combustor 450 is ignited, propelling the variable-cycle jet engine 400 to operate in the supersonic regime. Once ignited, the core engine inlet flow control 464 operates to substantially block entry of inlet air into the turbojet section 402 of the variable-cycle jet engine 400. The process is similarly reversed when decelerating to subsonic speeds. To assist with the various transitions between subsonic and supersonic operation, various variable vanes or struts may be employed to control flow rates and pressure levels within the core flow path C of the turbojet section 402, including an aft variable strut 467 positioned downstream of the turbine section 420.

This herein disclosure outlines a conventional turbojet or turbofan engine that accommodates a bifurcated inlet that feeds both the turbojet or turbofan engine and a wrap-around bypass stream that utilizes ram flow to feed a supplemental combustor configured to power the combined engine into supersonic operation. To optimize performance, a rotating detonation combustor serves as the supplemental combustor in this combined engine system. The engine system incorporates flow control and blocker systems that facilitate smooth transition from turbojet or turbofan mode to ram burner mode. Unlike other combined systems, the rotating detonation engine enables broad transition from subsonic through transonic to supersonic flight conditions. An articulating inlet flow blocker progressively directs flow to the ram air stream and then reduces the flow to the turbojet or turbofan engine during high-speed operation. The ram air flow blocker operates in an inverse fashion such that it does not participate in subsonic flight. A variable strut at the end of the turbomachine further assists with engine control during mode transition.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, system program instructions or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found by In Re Nuijten to fall outside the scope of patentable subject matter under 35 U.S.C. § 101.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Finally, any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A gas turbine engine, comprising:
a core engine section, including a compressor section, a primary combustor and a turbine section positioned within a core flow path of the gas turbine engine;
a ramjet section, including a supplemental combustor disposed within a ram duct, the ram duct located radially outside the core engine section; and
a core engine housing positioned radially outward of the core engine section and radially inward of the ramjet section.

2. The gas turbine engine of claim 1, wherein the supplemental combustor is a rotating detonation combustor.

3. The gas turbine engine of claim 2, wherein the rotating detonation combustor includes a fuel-air mixer configured to receive a compressed air and a fuel.

4. The gas turbine engine of claim 3, wherein the rotating detonation combustor includes an annular structure positioned downstream of the fuel-air mixer and configured to combust the compressed air and the fuel.

5. The gas turbine engine of claim 4, wherein the compressed air is provided to the rotating detonation combustor via the ram duct.

6. The gas turbine engine of claim 1, further comprising a bypass duct extending through the core engine housing, the bypass duct configured to provide a bypass flow from the core engine section to the ram duct.

7. The gas turbine engine of claim 1, further comprising a high-speed spool and wherein the compressor section includes a high-pressure compressor and the turbine section includes a high-pressure turbine, the high-pressure compressor and the high-pressure turbine being interconnected via the high-speed spool.

8. The gas turbine engine of claim 1, further comprising a low-speed spool and wherein the compressor section includes a low-pressure compressor and the turbine section includes a low-pressure turbine, the low-pressure compressor and the low-pressure turbine being interconnected via the low-speed spool.

9. The gas turbine engine of claim 8, wherein the core engine section is a turbofan engine comprising a fan section positioned upstream of the compressor section.

10. The gas turbine engine of claim 9, further comprising a ram inlet flow control configured to control a flow of inlet air into the ramjet section.

11. The gas turbine engine of claim 10, further comprising a core engine inlet flow control configured to control the flow of inlet air into the core engine section.

12. The gas turbine engine of claim 1, further comprising a bypass casing positioned radially outward of the core engine housing and radially inward of the ram duct, the bypass casing defining a bypass duct extending between the core engine housing and the bypass casing.

13. The gas turbine engine of claim 6, further comprising a single-speed spool configured to interconnect a compressor within the compressor section and a turbine within the turbine section.

14. A variable-cycle jet engine, comprising:
a core engine section, including a compressor section, a primary combustor and a turbine section positioned within a core flow path of the variable-cycle jet engine;
a ramjet section, including a supplemental combustor disposed within a ram duct, the ram duct located radially outside the core engine section; and
a core engine housing positioned radially outward of the core engine section and radially inward of the ramjet section.

15. The variable-cycle jet engine of claim 14, wherein the supplemental combustor is a rotating detonation combustor.

16. The variable-cycle jet engine of claim 15, wherein the rotating detonation combustor includes a fuel-air mixer configured to receive a compressed air and a fuel and an annular structure positioned downstream of the fuel-air mixer and configured to combust the compressed air and the fuel.

17. The variable-cycle jet engine of claim 16, wherein the compressed air is provided to the rotating detonation combustor via the ram duct.

18. The variable-cycle jet engine of claim 17, further comprising a ram inlet flow control configured to control a flow of inlet air into the ramjet section and a core engine inlet flow control configured to control the flow of inlet air into the core engine section.

19. The variable-cycle jet engine of claim 18, wherein the core engine section includes a turbofan engine.

20. The variable-cycle jet engine of claim 18, wherein the core engine section includes a turbojet engine.
